(19) United States
(12) Patent Application Publication
(10) Pub. No.: US 2011/0257812 A1
(43) Pub. Date: Oct. 20, 2011

(54) VEHICLE TRACKING SYSTEM

(75) Inventors: Carl Craig Carpenter, Mesa, AZ (US); Dennis Charles Chalker, Aurora, CO (US); Wellington Taylor Leonard, Scottsdale, AZ (US)

(73) Assignee: DD&C TRADING COMPANY LLC, Aurora, CO (US)

(21) Appl. No.: 12/761,672

(22) Filed: Apr. 16, 2010

(51) Int. Cl. G01S 19/46; G06K 7/10; G01S 3/02; G06F 19/00; H04M 1/00; H04W 24/00

(52) U.S. Cl. 701/2; 455/550.1; 455/456.5; 342/451; 342/357.29; 701/33; 235/385

(57) ABSTRACT

One or more tracked vehicles with wireless broadband connectivity to a central tracking station provide redundant location data derived from an onboard GPS receiver and an onboard self-triangulating cell phone. Tracking data for bar-coded and RFID-tagged items with the vehicle are also tracked. Clandestine audio monitoring of the vehicle interior and exterior can be enabled from the tracking station or from a remote access device. Redundant rollover sensing and reporting is provided by a roll over switch and a cell phone loss of signal. Hardwired and proximity vehicle panic alarms communicate with the central tracking station. A remote engine kill is provided. A tracking server within the tracking station stores data and generates reports and alarms. HF radio and cell phone communication between the tracking station and the vehicle are also enabled.

### FIELD OF THE INVENTION

This invention relates to a vehicle tracking system for tracking vehicles and cargo. The invention further relates to tracking vehicles in high-risk environments.

### BACKGROUND

With the emergence of the Global Positioning System (“GPS”) as the first global utility, systems for tracking vehicles have emerged onto the market. OnStar, made by General Motors, is one such system. The OnStar system can receive communications from the car regarding vehicle user's requests for assistance, and can detect a crash and send help to the crash site, based on GPS tracking data received periodically or responsively from the vehicle. OnStar does not monitor conversations within the vehicle unless the vehicle user initiates contact. OnStar does not monitor sounds outside the vehicle, nor provide proactive voice monitoring within the vehicle.

In high-threat environments, such as convoy duty in a war zone, unique problems arise. A high degree of situational awareness is at once required and difficult to add to the vehicle crew's already intense workload. Knowledge of what people are doing and saying outside and proximate to the vehicle can be crucial to mission success and crew survival. The vehicle crew needs more capabilities than it can provide itself.

### OBJECTS AND FEATURES OF THE INVENTION

A primary object and feature of the present invention is to overcome the above-mentioned problems and fulfill the above-mentioned needs.

Another object and feature of the present invention is to provide a vehicle tracking system that enables tracking from a centralized remote tracking station and by an individual who is remote from both the vehicle and the centralized tracking station. Another object and feature of the present invention is to provide a vehicle tracking system with a crew-usable capability to activate an alarm while in or proximate the vehicle. Another object and feature of the present invention is to provide a vehicle tracking system that provides multiple external communications paths. Another object and feature of the present invention is to provide a vehicle tracking system that apprises trackers of cargo and other resources onboard the vehicle. Another object and feature of the present invention is to provide a vehicle tracking system that provides trackers multiple means for locating the vehicle. Another object and feature of the present invention is to provide a vehicle tracking system that allows voices in the vehicle to be monitored without any initiating action from anyone in the vehicle. Another object and feature of the present invention is to provide a vehicle tracking system that allows voices proximate and exterior to the vehicle to be monitored without any initiating action from anyone in or proximate the vehicle. Another object and feature of the present invention is to provide a vehicle tracking system that enables a plurality of control circuit closures in the vehicle to be operated remotely.

### BRIEF DESCRIPTION OF THE DRAWINGS

The above and other objects and advantages of the present invention will become more apparent from the following description taken in conjunction with the following drawings in which:

FIG. 1 is a diagrammatic view illustrating an exemplary vehicle tracking system, according to a preferred embodiment of the present invention;

FIG. 2 is a diagrammatic view illustrating exemplary details of the exemplary redundant location determination and exemplary redundant roll-over determination subsystems of the exemplary vehicle tracking system, according to the preferred embodiment of FIG. 1;

FIG. 3 is a diagrammatic view illustrating exemplary details of the exemplary redundant panic alarm subsystem of the exemplary vehicle tracking system, according to the preferred embodiment of FIG. 1;

FIG. 4 is a diagrammatic view illustrating exemplary functions of a tracking operator in an exemplary centralized tracking station of the exemplary vehicle tracking system, according to the preferred embodiment of FIG. 1;

FIG. 5 is a diagrammatic view illustrating the exemplary item tracking system of the exemplary vehicle tracking system, according to the preferred embodiment of FIG. 1; and

FIG. 6 is a diagrammatic view illustrating exemplary functions of a remote user of the exemplary vehicle tracking system, according to the preferred embodiment of FIG. 1.

### SUMMARY OF THE INVENTION

A system for cooperative tracking of a vehicle that includes voice monitoring in and around the vehicle without any initiating action by the vehicle crew, provides multiple external communications paths, multiple approaches to determining location, multiple approaches to determining vehicle location, and remote monitoring from a centralized tracking station and from a remote individual. Redundant roll-over detection and panic alarms are also provided.

A vehicle tracking system including: a vehicle to be tracked, having a vehicle wireless broadband transmitter and a vehicle wireless broadband receiver; a location-determining subsystem able to supply location data to the vehicle wireless broadband transmitter for transmission; a tracking station having a station wireless broadband transmitter able to communicate with the vehicle wireless broadband receiver; a station wireless broadband receiver able to communicate with the vehicle wireless broadband transmitter; and a tracking server including the station wireless broadband transmitter and the station wireless broadband receiver; and a remote access device able to communicate with the vehicle wireless broadband transmitter and the vehicle wireless broadband receiver through the tracking server. The vehicle tracking system, where the location-determining subsystem includes two independent location determining subsystems. The vehicle tracking system1, where the location-determining subsystem includes: a GPS receiver and a cell phone able to access a cell phone triangulation service to perform self-location by triangulation. The vehicle tracking system1, where the vehicle to be tracked further includes a hardwired panic alarm fixed within the vehicle; a remote panic alarm that works near the vehicle; and a remote kill circuit. The vehicle tracking system, where the vehicle to be tracked further includes a plurality of subsystems for tracking items carried in and/or on the vehicle and able to generate item-tracking data regarding the items and to supply the item-tracking data to the vehicle wireless broadband transmitter for transmission. The vehicle tracking system, where the vehicle to be tracked further includes a bar code reader and an RFID tag reader. The vehicle tracking system1, where the vehicle to be tracked further includes a plurality of subsystems able to determine and report whether the vehicle has rolled over. The vehicle tracking system, where the vehicle to be tracked further includes a roll-over switch fixed to the vehicle and a cell phone antenna communicatively coupled to a cell phone and mechanically coupled to the vehicle, where the cell phone is able to report loss of signal. The vehicle tracking system, where the vehicle to be tracked includes: a microphone mechanically coupled to the vehicle; the microphone communicatively coupled to the vehicle wireless broadband transmitter and/or a cell phone; and where the vehicle wireless broadband transmitter and/or the cell phone is able to respond to a clandestine command from the tracking server to transmit audio signals from the microphone to the tracking server. The vehicle tracking system, where the microphone is mechanically coupled to the vehicle on either an interior or an exterior of the vehicle. The vehicle tracking system, where the vehicle to be tracked includes an HF radio and the tracking station includes an HF radio. The vehicle tracking system, including a user-defined process output interface to the vehicle wireless broadband transmitter; a user-defined process input interface to the vehicle wireless broadband receiver; and a user-defined process device able to be coupled to the user defined process input interface and to the user-defined process output interface.

A vehicle tracking system including a vehicle to be tracked including a vehicle wireless broadband transmitter; a vehicle wireless broadband receiver; and first and second independent location-determining subsystems able to supply location data to the vehicle wireless broadband transmitter for transmission; and an audio subsystem, able to be communicatively coupled to the vehicle wireless broadband transmitter and able to respond to a clandestine remote monitoring command to supply audio signals from the vehicle to the vehicle wireless broadband transmitter for transmission. a tracking station having a station wireless broadband transmitter able to communicate with the vehicle wireless broadband receiver; a station wireless broadband receiver able to communicate with the vehicle wireless broadband transmitter; and a tracking server including the station wireless broadband transmitter and the station wireless broadband receiver, where the tracking server is able to generate and transmit the remote monitoring command; and a remote access device able to communicate with the vehicle wireless broadband transmitter and the vehicle wireless broadband receiver through the tracking server. The vehicle tracking system, where the vehicle to be tracked further includes a plurality of subsystems for tracking items carried in and/or on the vehicle and able to generate item-tracking data regarding the items and supply the item-tracking data to the vehicle wireless broadband transmitter for transmission. The vehicle tracking system, where the vehicle to be tracked further includes a plurality of subsystems for determining and reporting whether the vehicle has rolled over. The vehicle tracking system, where the vehicle to be tracked includes a microphone mechanically coupled to the vehicle; the microphone communicatively coupled the vehicle wireless broadband transmitter and/or a cell phone; where the vehicle wireless broadband transmitter and/or a cell phone is able to respond to a command from the tracking server to transmit audio signals from the microphone to the tracking server. The vehicle tracking system, where the microphone includes: a microphone positioned to receive sounds originating in an interior portion of the vehicle and a microphone positioned to receive sounds originating from proximate an exterior portion of the vehicle. The vehicle tracking system, where the vehicle to be tracked further includes the combination of a hardwired panic alarm fixed within the vehicle and communicatively coupled to the vehicle wireless broadband transmitter; a remote panic alarm able proximate the vehicle; a remote kill circuit communicatively coupled to the vehicle wireless broadband transmitter and to a motor of the vehicle; a GPS receiver communicatively coupled to the vehicle wireless broadband transmitter; a cell phone mechanically coupled to the vehicle and communicatively coupled to a data storage unit, able to self-triangulate a position of the cell phone; a vehicle HF radio able to communicate with a station HF radio in the tracking station; an RFID tag reader communicatively coupled to the vehicle wireless broadband transmitter; and a bar code reader communicatively coupled to the vehicle wireless broadband transmitter; The vehicle tracking system, where the remote access device is able to provide two-way calling with a crew of the vehicle, clandestine voice monitoring of voices of such crew, and text messaging with such crew.

A vehicle tracking system including: a vehicle to be tracked including a vehicle wireless broadband transmitter, a vehicle wireless broadband receiver, and first and second independent location-determining subsystems able to supply location data to the vehicle wireless broadband transmitter for transmission; where the first location-determining subsystem includes a GPS receiver and the second location-determining subsystem includes a cell phone able to self-triangulate; and an audio subsystem, able to be communicatively coupled to the vehicle wireless broadband transmitter and able to respond to a remote monitoring command to clandestinely supply audio signals from the vehicle to the vehicle wireless broadband transmitter for transmission; first and second item-tracking subsystems for tracking items carried in and/or on the vehicle and able to generate item-tracking data regarding the items and supply the item-tracking data to the vehicle wireless broadband transmitter for transmission; and where the first item-tracking subsystem includes a bar code reader communicatively coupled to the vehicle wireless broadband transmitter and the second item-tracking subsystem includes an RFID tag reader communicatively coupled to the vehicle wireless broadband transmitter; a remote kill circuit communicatively coupled to the vehicle wireless broadband transmitter and to a motor of the vehicle; a hardwired panic alarm fixed within the vehicle and communicatively coupled to the vehicle wireless broadband transmitter; a remote panic alarm able proximate the vehicle; first and second roll-over detection subsystems able to detect and report a rolled-over orientation of the vehicle, where the first roll-over detection subsystem includes a roll-over switch and the second roll-over detection subsystem includes an antenna of the cell phone, where the cell phone is able to report loss of signal; a vehicle HF radio; a user-defined-process interface to the vehicle wireless broadband receiver and to the vehicle wireless broadband transmitter and a user-defined process device able to be coupled to the user-defined-process interface; and a tracking station having a station wireless broadband transmitter able to communicate with the vehicle wireless broadband receiver; a station wireless broadband receiver able to communicate with the vehicle wireless broadband transmitter; and a tracking server including the station wireless broadband transmitter and the station wireless broadband receiver, where the tracking server is able to generate and transmit the remote monitoring command; and where the tracking server is able to generate commands to the vehicle, collect and store data relating to the vehicle, and generate reports regarding the vehicle; and a remote access device able to communicate with the vehicle wireless broadband transmitter and the vehicle wireless broadband receiver through the tracking server to provide two-way calling with a crew of the vehicle; clandestine voice monitoring of voices of such crew; and text messaging with such crew.

### DETAILED DESCRIPTION OF THE PREFERRED EMBODIMENTS

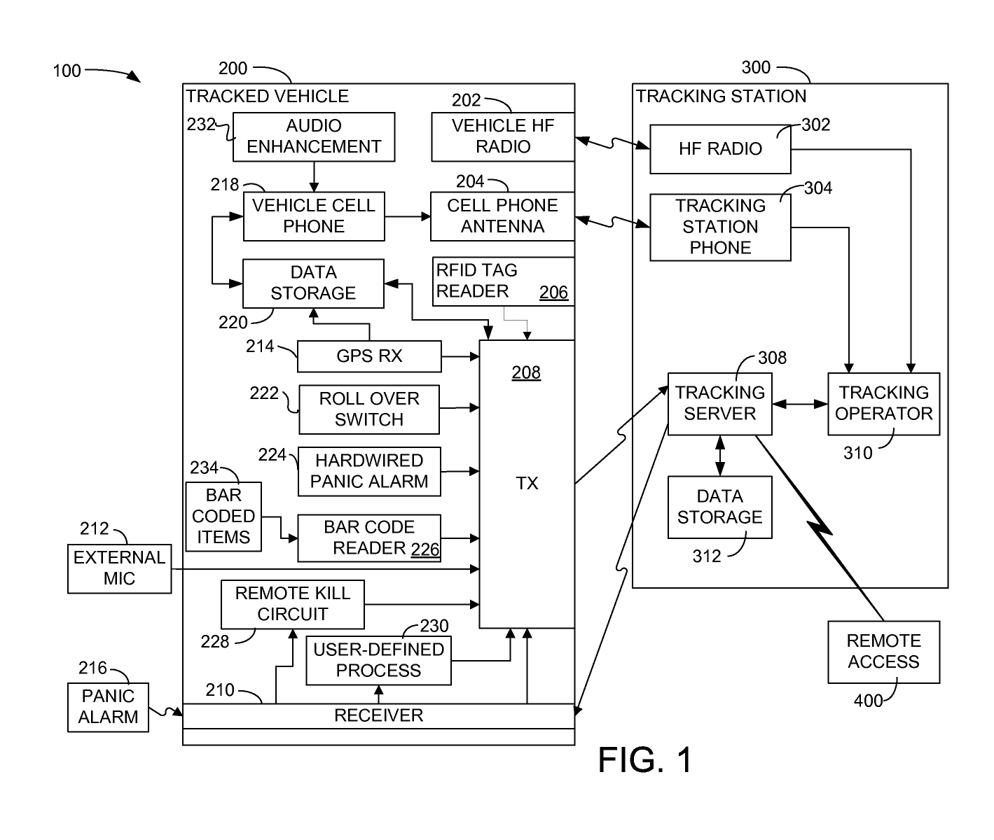

FIG. 1 is a diagrammatic view illustrating an exemplary vehicle tracking system 100, according to a preferred embodiment of the present invention. Vehicle tracking system 100 includes one or more vehicles 200 being tracked (hereinafter “tracked vehicle 200”), one or more centralized tracking stations 300 (hereinafter “tracking station 300”), and one or more remote access devices 400. Tracked vehicle 200 has at least one external microphone 212 for receiving sounds of activities proximate the exterior of tracked vehicle 200. Preferably, a plurality of external microphones 212 are used to provide sound reception coverage all around tracked vehicle 200. Tracked vehicle 200 also has at least one remote panic alarm 216 that can be operated by crew members when not inside tracked vehicle 200. The remote panic alarm 216 communicates to a receiver 210 in the tracked vehicle 200, which sends the alarm signal to a broadband internet transmitter 208 in the tracked vehicle 200 for communication to a tracking server 308 in tracking station 300, which displays the alarm to tracking operator 310 (a human being) to initiate responsive action. The broadband transmitter 208 also transmits data from hardwired panic alarm 224 inside the tracked vehicle 200. Transmitter 208 is preferably an internet broadband transmitter but may be, in alternate embodiments, a satellite broadband transmitter 208. In a preferred embodiment, broadband transmitter 208 and broadband receiver 210 are integral components of a broad band access device in a personal computer.

The location determination subsystem includes GPS receiver 214 that produces location data 410 regarding position and velocity of the tracked vehicle 200 for: transmission from broadband transmitter 208 to the tracking server 308 in tracking station 300; display (not shown) within the tracked vehicle 200; and for onboard data storage 220. In a particular embodiment, GPS receiver 214 may include a differential GPS receiver. In an alternate embodiment, multiple redundant GPS receivers 214 may be used. In such an alternate embodiment, the multiple redundant GPS receivers 214 may be used to compute orientation of the tracked vehicle 200. GPS receiver 214 may produce a compass reading for display within the tracked vehicle 200. GPS data may alternatively or redundantly be sent over a data channel of vehicle cell phone 218.

The roll-over detection subsystem includes roll over switch 222 produces data indicative of whether or not the tracked vehicle 200 has rolled over, perhaps in response to an accident or improvised explosive device. Data from the roll over switch 222 is transmitted by broadband transmitter 208 to the tracking server 308 in the tracking station 300. Tracking server 308 includes broadband connectivity. Those of skill in the art will appreciate that broadband transmitter 208 and broadband receiver 210 may be physically instantiated in a single box (such as a broadband access card in a personal computer) within tracked vehicle 200 and may share an antenna.

User-defined process 230 receives data via receiver 210, actuates a process, and sends data to transmitter 208 for communication to tracking server 308. Process actuation may be, for non-limiting example, via control circuit closures (relay logic) to turn subsystems on or off, fire defensive ordnance, turn on lights, activate rescue beacons, or the like. Software processes may also be actuated via user-defined process 230.

Remote kill circuit 228 turns off the motor of the tracked vehicle 200 responsive to a signal received by receiver 210 from the tracking server 308. Preferably, after remote kill circuit 228 is activated, a second signal is required to deactivate the remote kill circuit 228. In an alternate embodiment, all broadband signals between tracking server 308 and broadband transmitter 208 and broadband receiver 210 are encrypted. In a particular embodiment, activation of remote kill circuit 228 permanently destroys the ignition control circuit for the vehicle motor, requiring replacement parts to restart the tracked vehicle 200. In a particular embodiment, remote kill circuit 228 may also include a crew input in tracked vehicle 200 to enable the crew to kill the motor if it appears that the vehicle may be lost. In particular embodiments, hardwired panic alarm 224 and remote panic alarm 216 may serve such a function.

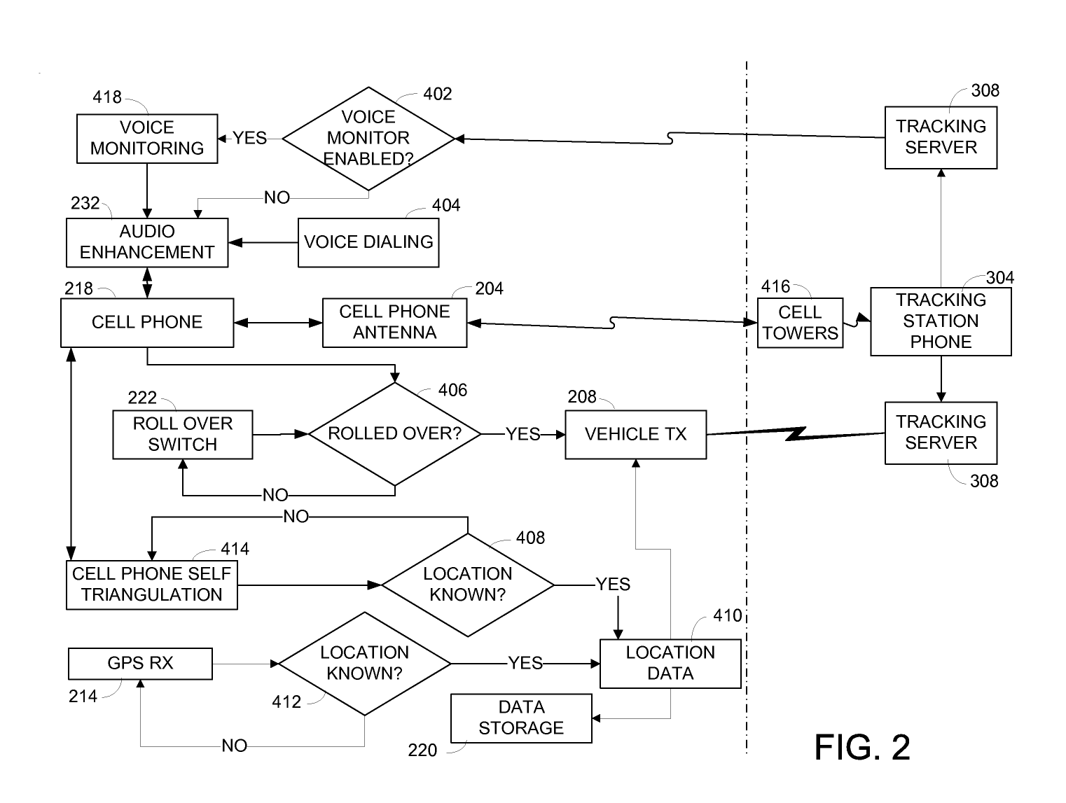

Tracked vehicle 200 has redundant communication paths to tracking station 300. In addition to RF transmitter 208, an HF radio 202 and a vehicle cell phone 218 are provided. Vehicle HF radio 202 in tracked vehicle 200 provides voice communication with the HF radio 302 in tracking station 300. The HF signals between HF radios 202 and 302 are preferably encrypted. Vehicle cell phone 218 preferably has voice and data transmission capability. Voice and data from vehicle cell phone 218 are preferably recorded in onboard data storage 220. Vehicle cell phone 218 is preferably built-in to the tracked vehicle 200 but, in a particular embodiment, may be removable. Audio enhancement 232 to vehicle cell phone 218 enables voice dialing 404 (see FIG. 2) and clandestine voice monitoring 418, which will be discussed in more detail below.

Cell phone antenna 204 also acts as part of the roll-over detection subsystem by serving as a redundant roll over indicator. When the vehicle 200 rolls over, the cell phone antenna 204 is covered and the cell phone 218 reports loss of signal to indicate a roll over. In a particular embodiment, vehicle cell phone 218 may be or may include an Iridium® satellite phone.

Bar code reader 226 is part of the item-tracking subsystems and transfers data from bar-coded items 234 to broadband transmitter 208 and, optionally, to onboard data storage 220. From broadband transmitter 208, the information is communicated to tracking server 308, stored in station data storage 312, and displayed for tracking operator 310. Bar-coded items 234 may be, for non-limiting example, cargo, equipment for tracked vehicle 200 or for crew personnel, ordnance, weapons, and supplies. By having an inventory of bar-coded items 234, the tracking operator 310 can assess the cost of potential loss and evaluate risks accordingly. The bar codes and bar code reader 206 may be of any commercially available type.

The RFID tag reader 206 is another part of the item tracking subsystem. RFID tags attach to items and generate RF signals unique to each individual RFID tag, allowing tracking of the items to which RFID tags are attached. An RFID tag reader 206 located in the tracked vehicle 200, reads the RFID tags for tagged items within and near the tracked vehicle 200 and provides them to the broadband transmitter 208 for transmission to the tracking server 308. Items to which RFID tags may be attached include, for non-limiting example, the tracked vehicle 200, crew personnel, and all the items listed above as exemplary bar-coded items 234.

Tracking station 300 may be fixed or mobile. Tracking station 300 includes the tracking server 308, and associated power supplies and infrastructure. Tracking server 308 preferably communicates with the tracked vehicle 200 via broadband internet. Most preferably, the communication link is cellular broadband. Less preferably, the link is via satellite broadband. In an alternate embodiment, both cellular broadband and satellite broadband may be included for redundant or alternative use. Tracking server 308 stores data in data storage 312, which preferably includes hard drives. Tracking server 308 includes a human-machine interface for displaying information to the tracking operator 310 and for receiving commands and data from the tracking operator 310. Tracking operator 310 also has voice access to tracked vehicle 200 via a tracking station phone 304 and via HF radio 302. Tracking station phone 304 may be a landline phone, cell phone, or satellite phone, as desired.

Remote access device 400 provides broadband connectivity to the tracking server 308 and enables a remote user to perform any subset of tracking server 308 monitoring, communicating, or commanding tasks desired for a particular embodiment. IN an alternate embodiment, the broadband link between the remote access device 400 and the tracking server 308 may be encrypted. More will discussed about this below.

FIG. 2 is a diagrammatic view illustrating exemplary details of the exemplary redundant location determination 214, 414 and exemplary redundant roll-over determination 222, 204 subsystems of the exemplary vehicle tracking system 100, according to the preferred embodiment of FIG. 1. Note that tracking server 308 is depicted twice for simplicity of the drawing, but both depictions are the same device. A command to enable or disable clandestine voice monitoring 418 in and near tracked vehicle 200 may be sent from tracking server 308 to switch logic 402 in the tracked vehicle 200. If clandestine voice monitoring 418 is turned on it operates through audio enhancement 232 to vehicle cell phone 218 to enable the tracking operator 310 to hear sounds in and near the tracked vehicle 200. Audio enhancement 232 also enables voice dialing 404.

Roll over logic 406 receives inputs from roll over switch 222 and a binary indication of loss of signal from cell phone antenna 204. If either of such inputs indicate rollover, a rollover alarm is sent via broadband transmitter 208 to tracking server 308 for display to the tracking operator 310.

GPS receiver 214, previously described, determines position data and additional parameters. If the GPS receiver 214 has resolved position coordinates, it so indicates to GPS location logic 412, and location data 410, as well as additional parameters, is sent via broadband transmitter 208 to tracking server 308. The location data 410 and additional parameters are also stored in onboard data storage 220. Additional parameters may include, without limitation, identification of the mapping system for which the location data 410 are valid, the velocity vector and speed of the tracked vehicle 200, the altitude of the tracked vehicle 200, and the compass heading of the tracked vehicle 200. If GPS receiver 214 does not generate location data 410, GPS location logic 412 waits for location data 410.

Vehicle cell phone 218 is capable of accessing, via its data link, cell phone triangulation services in order to perform cell phone self triangulation 414, as a redundant position determining method in the location determination subsystem. Cell phone self triangulation 414 uses data from cell towers 416 to triangulate a position. If the cell phone self triangulation 414 produces a result, it so indicates to cell phone location logic 408, which sends the location data 410 to the tracking server 308 via broadband transmitter 208. Location data 410 from the cell phone self triangulation 414 is also stored in onboard data storage 220. If cell phone self triangulation 414 does not generate location data 410, cell phone location logic 412 waits for location data 410. Cell phone self triangulation 414 may operate periodically or responsive to discrete command.

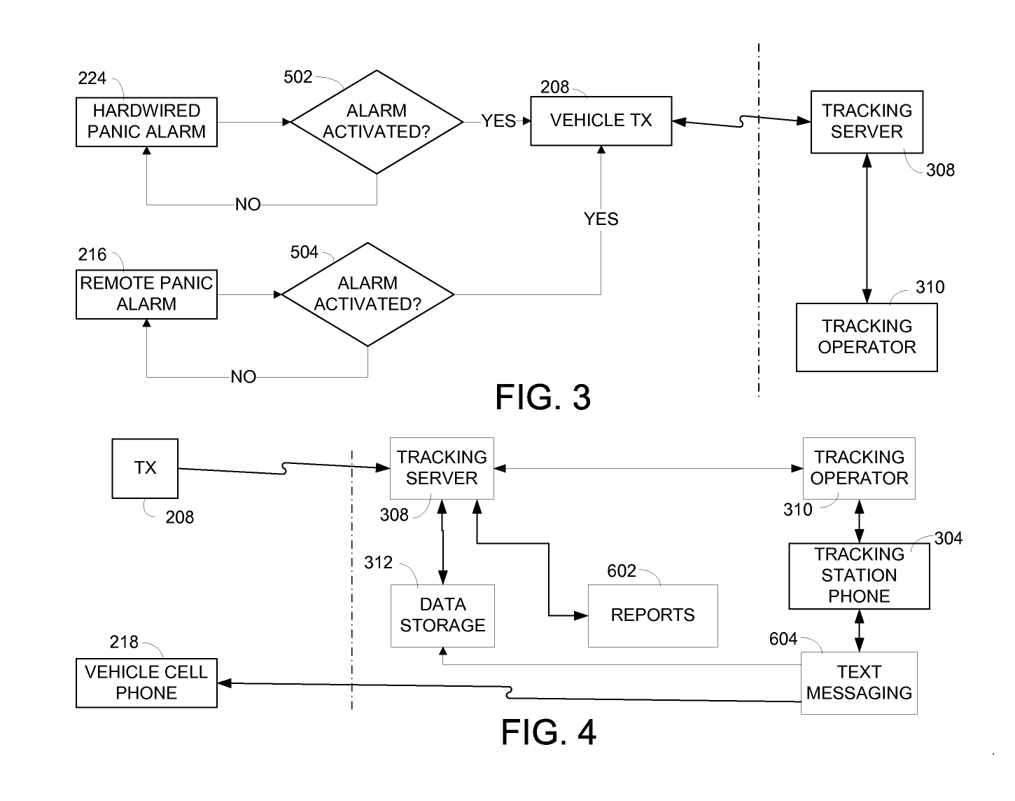

FIG. 3 is a diagrammatic view illustrating exemplary details of the exemplary redundant panic alarm 216, 224 subsystem of the exemplary vehicle tracking system 100, according to the preferred embodiment of FIG. 1. Hardwired panic alarm 224 in tracked vehicle 200 sends a signal to hardwired panic alarm logic 502, when activated, causing the hardwired panic alarm logic 502 to send an alarm to tracking server 308 via broadband transmitter 208. The alarm is displayed, visually and audibly, to the tracking operator 310, along with an indication that it was the hardwired panic alarm 224 that activated. Remote panic alarm 216 in or near tracked vehicle 200 sends a signal to remote panic alarm logic 504, when activated, causing the remote panic alarm logic 502 to send an alarm to tracking server 308 via broadband transmitter 208. The alarm is displayed, visually and audibly, to the tracking operator 310, along with an indication that it was the remote panic alarm 224 that activated.

FIG. 4 is a diagrammatic view illustrating exemplary functions of a tracking operator 310 in an exemplary centralized tracking station 300 of the exemplary vehicle tracking system 100, according to the preferred embodiment of FIG. 1. Data transmitted from vehicle broadband transmitter 208 is received by tracking server 308 for display to tracking operator 310. Tracking server 308 stores data in station data storage 312, which is preferably hard drive storage. Tracking operator 310 interacts with the tracking server 308 to command production of reports 602 from the stored data in station data storage 312. Tracking operator 310 uses the tracking station phone 304 for voice communication and text messaging 604 with the vehicle cell phone 218. The vehicle cell phone 218 may be integrated with an onboard computer in the tracked vehicle 200, or may be a stand-alone device. The tracking station phone 304 may be integrated with the tracking server 308 or other computer in the tracking station 300, or may be a stand-alone device. Reports 602 may include, without limitation, historical position data with or without map tracing, vehicle speed history, and mileage reporting.

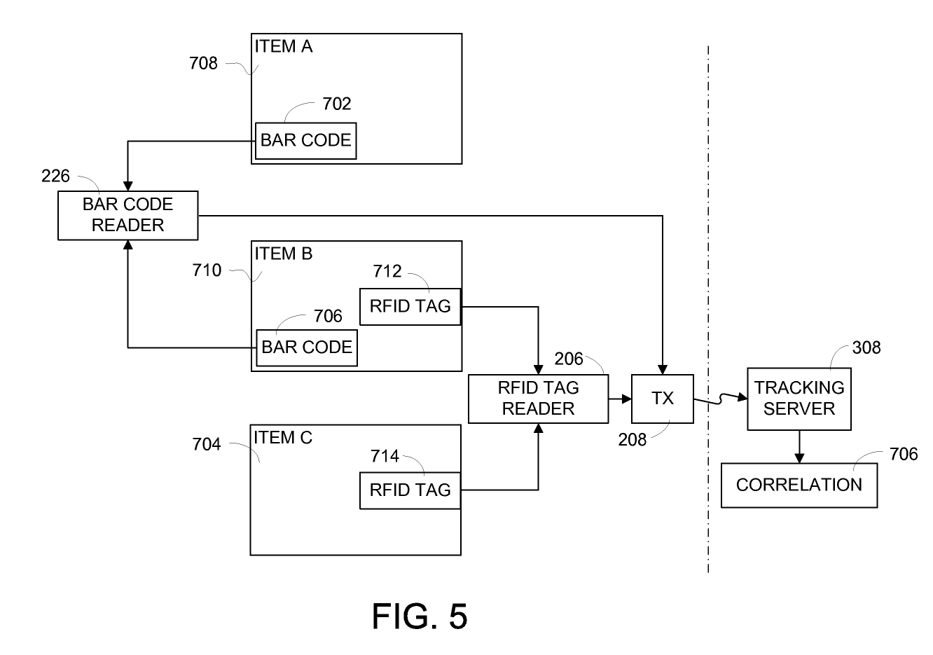

FIG. 5 is a diagrammatic view illustrating the exemplary item tracking 206, 226 subsystem of the exemplary vehicle tracking system 100, according to the preferred embodiment of FIG. 1. Bar-coded items 708 and 710 of bar-coded items 234 and RFID tagged items 704 and 710 are carried in or on tracked vehicle 200. Bar code reader 226 is manually operated to read bar codes 702 and 706 on items 708 and 710. Each bar code 702 and 706 identifies the bar-coded item 708 and 710, respectively. Data collected by bar code reader 226 is supplied to tracking server 308 via broadband transmitter 208.

Item 710 also has an RFID tag 712 and item 704 has only an RFID tag. RFID tags 712 and 714 are read by RFID tag reader 206 and the data thus obtained is supplied to the tracking server 308 via broadband transmitter 208. The tracking server may perform correlations 706 between items 704, 708, and 710 and tracked vehicle 200 to ensure that the correct items are onboard and that no needed items are missing. In some instances, the number of items carried by tracked vehicle 200 may be very large.

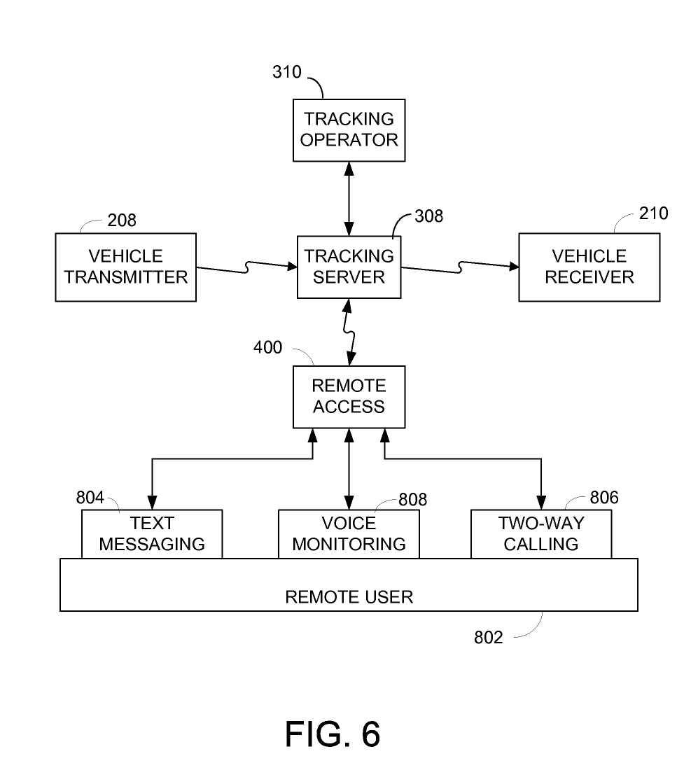

FIG. 6 is a diagrammatic view illustrating exemplary functions of a remote access device 400 of the exemplary vehicle tracking system, according to the preferred embodiment of FIG. 1. Remote user 802 operates remote access device 400 which may be a wireless broadband device, a wired broadband device, or an internet compatible device 400 connected to the internet when in use. Remote access device 400 communicates through the tracking server 308 to vehicle receiver 210 to enable at least text messaging 804 to, voice monitoring 808 of, and two-way calling 806 with, the tracked vehicle 200. Tracking operator 320 has visibility into the use of the remote access device 400 and can block such use, if needed.

Although applicant has described applicant's preferred embodiments of this invention, it will be understood that the broadest scope of this invention includes such modifications as diverse electronic components, communication systems, vehicles, and computers. Such scope is limited only by the below claims as read in connection with the above specification. Further, many other advantages of applicant's invention will be apparent to those skilled in the art from the above descriptions and the below claims.

We claim:

1. A vehicle tracking system comprising:
a. at least one vehicle to be tracked having:
i. a vehicle wireless broadband transmitter and a vehicle wireless broadband receiver; and
ii. at least one location-determining subsystem operable to supply location data to said vehicle wireless broadband transmitter for transmission;
b. a tracking station having:
i. a station wireless broadband transmitter operable to communicate with said vehicle wireless broadband receiver;
ii. a station wireless broadband receiver operable to communicate with said vehicle wireless broadband transmitter; and
iii. a tracking server comprising said station wireless broadband transmitter and said station wireless broadband receiver; and
c. a remote access device operable to communicate with said vehicle wireless broadband transmitter and said vehicle wireless broadband receiver through said tracking server.

2. The vehicle tracking system of claim 1, wherein said at least one location-determining subsystem comprises two independent location determining subsystems.

3. The vehicle tracking system of claim 1, wherein said at least one location-determining subsystem comprises:
a. a GPS receiver; and
b. a cell phone operable to access a cell phone triangulation service to perform self-location by triangulation.

4. The vehicle tracking system of claim 1, wherein said at least one vehicle to be tracked further comprises:
a. a hardwired panic alarm fixed within said at least one vehicle;
b. a remote panic alarm operable proximate said at least one vehicle; and
c. a remote kill circuit.

5. The vehicle tracking system of claim 1, wherein said at least one vehicle to be tracked further comprises a plurality of subsystems for tracking items carried at least one of in and on said at least one vehicle and operable to:
a. generate item-tracking data regarding said items; and
b. supply said item-tracking data to said vehicle wireless broadband transmitter for transmission.

6. The vehicle tracking system of claim 1, wherein said at least one vehicle to be tracked further comprises:
a. a bar code reader; and
b. an RFID tag reader.

7. The vehicle tracking system of claim 1, wherein said at least one vehicle to be tracked further comprises a plurality of subsystems operable to determine and report whether said at least one vehicle has rolled over.

8. The vehicle tracking system of claim 1, wherein said at least one vehicle to be tracked further comprises:
a. a roll-over switch fixed to said at least one vehicle; and
b. a cell phone antenna communicatively coupled to a cell phone and mechanically coupled to said at least one vehicle, wherein said cell phone is operable to report loss of signal.

9. The vehicle tracking system of claim 1, wherein said at least one vehicle to be tracked comprises:
a. at least one microphone mechanically coupled to said at least one vehicle;
b. said at least one microphone communicatively coupled to at least one of said vehicle wireless broadband transmitter and a cell phone; and
c. wherein said at least one of said vehicle wireless broadband transmitter and a cell phone is operable to respond to a clandestine command from said tracking server to transmit audio signals from said at least one microphone to said tracking server.

10. The vehicle tracking system of claim 9, wherein said at least one microphone is mechanically coupled to said at least one vehicle on one of an interior and an exterior of said at least one vehicle.

11. The vehicle tracking system of claim 1, wherein:
a. said at least one vehicle to be tracked comprises an HF radio; and
b. said tracking station comprises an HF radio.

12. The vehicle tracking system of claim 1, comprising:
a. a user-defined process output interface to said vehicle wireless broadband transmitter;
b. a user-defined process input interface to said vehicle wireless broadband receiver; and
c. at least one user-defined process device operable to be coupled to said at least one user defined process input interface and to said at least one user-defined process output interface.

13. A vehicle tracking system comprising:
a. at least one vehicle to be tracked comprising:
i. a vehicle wireless broadband transmitter;
ii. a vehicle wireless broadband receiver; and
iii. first and second independent location-determining subsystems operable to supply location data to said vehicle wireless broadband transmitter for transmission; and
iv. an audio subsystem, operable to be communicatively coupled to said vehicle wireless broadband transmitter and operable to respond to a clandestine remote monitoring command to supply audio signals from said at least one vehicle to said vehicle wireless broadband transmitter for transmission.
b. a tracking station having:
i. a station wireless broadband transmitter operable to communicate with said vehicle wireless broadband receiver;
ii. a station wireless broadband receiver operable to communicate with said vehicle wireless broadband transmitter; and
iii. a tracking server comprising said station wireless broadband transmitter and said station wireless broadband receiver, wherein said tracking server is operable to generate and transmit said remote monitoring command; and
c. a remote access device operable to communicate with said vehicle wireless broadband transmitter and said vehicle wireless broadband receiver through said tracking server.

14. The vehicle tracking system of claim 13, wherein said at least one vehicle to be tracked further comprises a plurality of subsystems for tracking items carried at least one of in and on said at least one vehicle and operable to:
a. generate item-tracking data regarding said items; and
b. supply said item-tracking data to said vehicle wireless broadband transmitter for transmission.

15. The vehicle tracking system of claim 13, wherein said at least one vehicle to be tracked further comprises a plurality of subsystems for determining and reporting whether said at least one vehicle has rolled over.

16. The vehicle tracking system of claim 13, wherein said at least one vehicle to be tracked comprises:
a. at least one microphone mechanically coupled to said at least one vehicle;
b. said at least one microphone communicatively coupled to at least one of said vehicle wireless broadband transmitter and a cell phone;
c. wherein said at least one of said vehicle wireless broadband transmitter and a cell phone is operable to respond to a command from said tracking server to transmit audio signals from said at least one microphone to said tracking server.

17. The vehicle tracking system of claim 13, wherein said at least one microphone comprises:
a. at least one microphone positioned to receive sounds originating in at least one interior portion of said at least one vehicle; and
b. at least one microphone positioned to receive sounds originating from proximate at least one exterior portion of said at least one vehicle.

18. The vehicle tracking system of claim 13, wherein said at least one vehicle to be tracked further comprises the combination of:
a. a hardwired panic alarm fixed within said at least one vehicle and communicatively coupled to said vehicle wireless broadband transmitter;
b. a remote panic alarm operable proximate said at least one vehicle;
c. a remote kill circuit communicatively coupled to said vehicle wireless broadband transmitter and to a motor of said vehicle;
d. a GPS receiver communicatively coupled to said vehicle wireless broadband transmitter;
e. at least one cell phone mechanically coupled to said at least one vehicle and communicatively coupled to a data storage unit, operable to self-triangulate a position of said at least one cell phone;
f. a vehicle HF radio operable to communicate with a station HF radio in said tracking station;
g. an RFID tag reader communicatively coupled to said vehicle wireless broadband transmitter; and
h. a bar code reader communicatively coupled to said vehicle wireless broadband transmitter.

19. The vehicle tracking system of claim 13, wherein said remote access device is operable to provide:
a. two-way calling with a crew of said at least one vehicle;
b. clandestine voice monitoring of voices of such crew; and
c. text messaging with such crew.

20. A vehicle tracking system comprising:
a. at least one vehicle to be tracked comprising:
i. a vehicle wireless broadband transmitter;
ii. a vehicle wireless broadband receiver; and
iii. first and second independent location-determining subsystems operable to supply location data to said vehicle wireless broadband transmitter for transmission, wherein said first location-determining subsystem comprises a GPS receiver and said second location-determining subsystem comprises a cell phone operable to self-triangulate; and
iv. an audio subsystem, operable to be communicatively coupled to said vehicle wireless broadband transmitter and operable to respond to a remote monitoring command to clandestinely supply audio signals from said at least one vehicle to said vehicle wireless broadband transmitter for transmission;
v. first and second item-tracking subsystems for tracking items carried at least one of in and on said at least one vehicle and operable to:
1. generate item-tracking data regarding said items;
2. supply said item-tracking data to said vehicle wireless broadband transmitter for transmission; and
3. wherein said first item-tracking subsystem comprises a bar code reader communicatively coupled to said vehicle wireless broadband transmitter and said second item-tracking subsystem comprises an RFID tag reader communicatively coupled to said vehicle wireless broadband transmitter;
vi. a remote kill circuit communicatively coupled to said vehicle wireless broadband transmitter and to a motor of said vehicle;
vii. a hardwired panic alarm fixed within said at least one vehicle and communicatively coupled to said vehicle wireless broadband transmitter;
viii. a remote panic alarm operable proximate said at least one vehicle;
ix. first and second roll-over detection subsystems operable to detect and report a rolled-over orientation of said at least one vehicle, wherein said first roll-over detection subsystem comprises a roll-over switch and said second roll-over detection subsystem comprises an antenna of said cell phone, wherein said cell phone is operable to report loss of signal;
x. a vehicle HF radio;
xi. a user-defined-process interface to said vehicle wireless broadband receiver and to said vehicle wireless broadband transmitter and at least one user-defined process device operable to be coupled to said at least one user-defined-process interface; and
b. a tracking station having:
i. a station wireless broadband transmitter operable to communicate with said vehicle wireless broadband receiver;
ii. a station wireless broadband receiver operable to communicate with said vehicle wireless broadband transmitter; and
iii. a tracking server comprising said station wireless broadband transmitter and said station wireless broadband receiver, wherein said tracking server is operable to generate and transmit said remote monitoring command; and
iv. wherein said tracking server is operable to generate commands to said at least one vehicle, collect and store data relating to said at least one vehicle, and generate reports regarding said at least one vehicle; and
c. a remote access device operable to communicate with said vehicle wireless broadband transmitter and said vehicle wireless broadband receiver through said tracking server to provide:
i. two-way calling with a crew of said at least one vehicle;
ii. clandestine voice monitoring of voices of such crew; and
iii. text messaging with such crew.
